(19) United States
(12) Patent Application Publication
(10) Pub. No.: US 2010/0001834 A1
(43) Pub. Date: Jan. 7, 2010

(54) SYSTEM AND METHOD FOR A MESSAGE REGISTRY AND MESSAGE HANDLING IN A SERVICE -ORIENTED BUSINESS FRAMEWORK

(76) Inventors: Frank Brunswig, Heidelberg (DE); Ioannis Grammatikakis, Maxdorf (DE); Dinu Pavithran, Bangalore (IN); Guenter Pecht-Seibert, Muhlhausen (DE); Michael Picht, Waldorf (DE); Alexander Rauh, Weinheim (DE); Holger Schmidt, Sinsheim (DE); Abhay Tiple, Sandhausen (DE)

Correspondence Address: KENYON & KENYON LLP, 1500 K STREET N.W., WASHINGTON, DC, 20005, US

(21) Appl. No.: 12/168,155

(22) Filed: Jul. 6, 2008

(51) Int. Cl. H04Q 1/30

(52) U.S. Cl. 340/7.51

(57) ABSTRACT

A system and method are provided for handling a notification message in an enterprise services framework, including in response to the saving of a transaction, sending a notification message to the enterprise system framework, the notification message containing an associated message class including information of message severity and message symptom. The framework includes a controller layer situated between a service management layer and a business object layer, the controller layer maintaining a message registry database which collects and stores the notification message and the information of message severity, message symptom, and message identification. A system and method is provided for the hierarchical handling of software objects, including providing software objects, each associated with a user interface message, hierarchically associating the user interface messages, and displaying those messages in a tree structure in association with each of the software objects.

### FIELD OF THE INVENTION

The present invention generally relates to a system, method, and computer-readable medium for a message registry and a message handling of, e.g., an error message, for a transaction in a service-oriented business framework.

### BACKGROUND INFORMATION

Generally, business objects of a service layer do not have knowledge about the specific usage scenario associated thereto. In addition, there has been no notification or propagation of a success message to a user interface after saving a transaction successfully. In such situations, the business objects can only generate a message related to the well-known context of the business object itself. Such behavior can lead to a number of unrelated messages on the user interface at each interaction cycle. Thus, there exists a need to provide a method and/or system in which a business object can generate a success or failure message. For example, in the past, the service provider of the business object has not been able generate a success message due to, for example, its inability to know the current application context and/or usage scenario.

Further, simple user interface messages such as error or warning messages are not conveniently provided to users. For example, a specific error message may have a specific history or earlier causes for the error. However, existing systems do not appear to provide an efficient means for handling such messages and providing a user or system with a convenient, comprehensive review of related messages, e.g., error messages, for which, for example, there is no XML document which can reference another XML document. Instead, such handling of related error messages involved a user looking manually at the error messages to determine the chain of events, e.g., error events, and their specific details. Accordingly, there exists a need to associate such messages related for a specific criteria(s) in an efficient manner.

### BRIEF DESCRIPTION OF THE DRAWINGS

FIG. 1 shows an example business object.

FIG. 2 shows an example message class diagram.

FIG. 3 shows information contained by a message class according to an embodiment of the present invention.

FIG. 4 shows a message registry data scheme according to an embodiment of the present invention.

FIG. 5 shows attributes as contained in a message registry data scheme according to an embodiment of the present invention.

FIG. 6 shows a hierarchical order corresponding to call stack and context according to an embodiment of the present invention.

FIG. 7 shows a message mapping diagram according to an embodiment of the present invention.

FIG. 8 shows example message classes according to an embodiment of the present invention.

FIG. 9 shows an example message visitor according to an embodiment of the present invention.

FIG. 10 shows an embodiment of the process agent framework.

### DETAILED DESCRIPTION

Embodiments of the present invention provide for a system, method, and computer-readable medium, for a smart and user-friendly user interface based on a model-driven and service-oriented architecture. Embodiments of the present invention provide for a system, method, and computer-readable medium, for a message handling system, e.g., an error message handling system, in a service-oriented architecture.

In embodiments of the present invention, a separate logic layer is provided to serve as an additional controller layer between the service management layer and the business object layers in a model-driven and service-oriented architecture. In an embodiment, the separate logic layer is aware of the specific context of the entire application and the usage scenario. Generally, a business object, for example, does not have knowledge of the usage scenario. In an embodiment, such a controller layer provides notification and point in time to propagate a success message to the user interface after saving a transaction successfully. In an embodiment, a message registry is provided which collects, stores and maintains all relevant information about a message of the service and application layer. Such information in the message registry may be used by the controller layer. An embodiment of the message registry provides a message mapping of the application protocol service layer to the application layer messages displayed in the user interface. In an embodiment of the message registry, metadata is used to describe a message. In an embodiment of the message handling, an error message which is associated with another error message is tracked and/or kept associated with the other so that a history of such related error messages can be viewed, if needed. In a further embodiment of message handling, the error messages are associated in a tree fashion such that one stems from another. In an alternative embodiment of message handling, the error messages which are associated with each other are identifiable as such so that all can be displayed if needed.

The message registry consists of a runtime part and a design-time part to collect, store, and maintain all relevant information about a message of the service and application layer. This can be used later in a message handling reuse service. The content of the message registry is the basis for the message mapping of the AP (application platform) service layer messages to the more user-friendly application layer messages displayed in a user interface. It contains the information about, for example, associated T100 message classes and it allows the enrichment of this data like maintenance of the data types of the message attributes.

Embodiments of the present invention provide for a comprehensive message handling service. In an embodiment, the complete lifetime management of messages based on the message buffer concept are supported by the framework. Messages which are not known to the framework must be propagated to the consumer. In an embodiment, for sophisticated message mapping challenges, a breakout mechanism, e.g., a programming interface, is supported which allows the adding of custom coding in a convenient manner. In an embodiment, after successfully saving a transaction, an appropriate success message is provided. Such messages are configurable and the framework may take care of displaying such messages. In a further embodiment, the text of the success message includes the terminology of the UI process and might be concatenated in the content of fields which are available in the business objects. In an embodiment, the text of an error message is adjustable to contain the terminology of the user interface process. For example, the business object entities of a message are expressed in terms of the user interface (e.g., actions, labels, etc.). In an embodiment, the aggregation and condensation of messages are supported. This may include the filtering of messages of special types under special conditions. The condensation concerns subsequent error situations. In an embodiment, the conversions of technical formats to readable texts, e.g., status codes, and special-type conversions, e.g., dates, number, amount, are supported. If such features are not provided by the infrastructure, then they must be covered by the reuse service. In an embodiment, data type information is used in the generic format conversions of messages. In an embodiment, the information about messages including the granularity of the appearance is maintainable manually. Further, such information may be added to the configuration tool by hand.

In an embodiment, a message registry includes a runtime part and a design-time part to collect, store, and maintain all relevant information about a message of the service and application layer, which later can be used in a message handling reuse service. The content of the message registry is the basis for the message mapping of the application platform (AP) service layer messages to application layer messages displayed in a user interface.

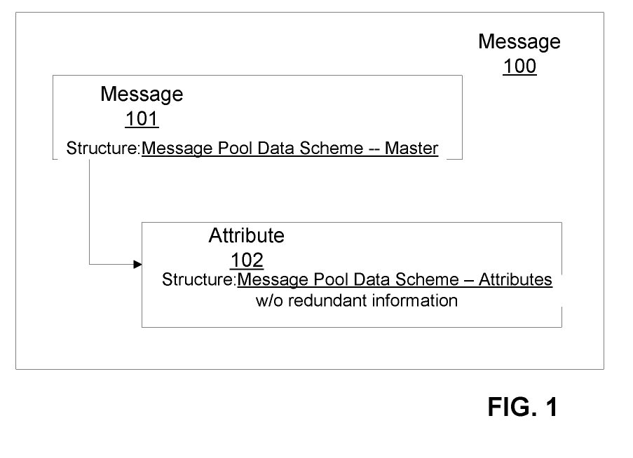

FIG. 1 shows an example message business object node structure 100. Specifically, the message business object includes a root node, the text node 101 having a structure, for example, such as Message_Pool_Data_Scheme-Master, and an associated attributes node 102.

In an embodiment, the message business object includes a root node, the text node, and the attributes node. In this example the language dependent content of the text node is provided via the T100 information. The message business object root node has the structure, for example, of the Message Registry Data Scheme-Master table shown above. The root node provides at least the “SearchByDetails” query. The input parameter structure of the “SearchByDetails” query is also the “Message Registry Data Scheme-Master.” The “Transport” action with cardinality 1 . . . n allows to assign and trigger a transport request manually for a number of selected entries. An appropriate value help is used to search for transport numbers. The message business object attributes node has the structure of the “Message Registry Data Scheme-Attributes” table.

An example message business object entries may include a software component, a business object name (e.g., Message), a node structure, an attribute(s) listing, and information about the root node.

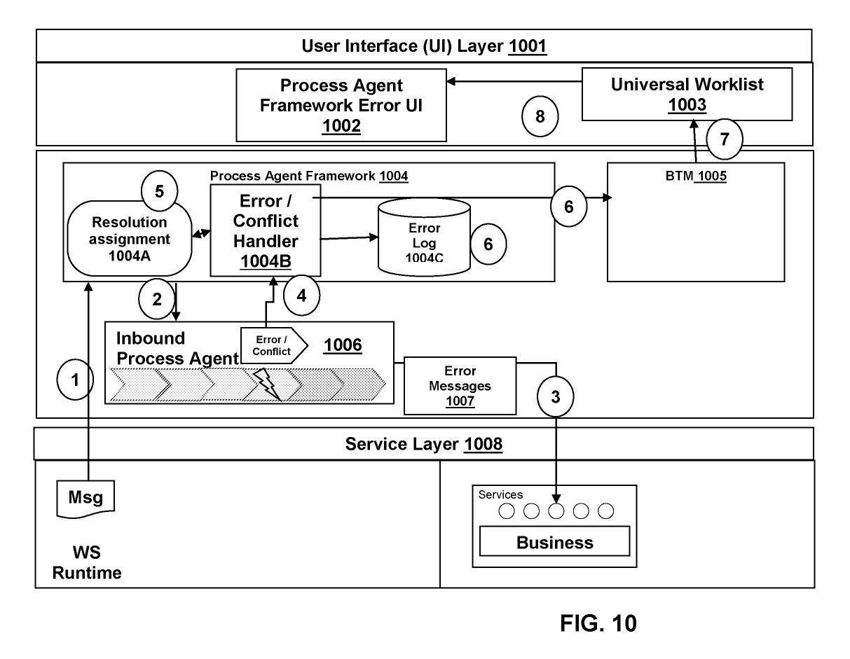

In an embodiment, realizing a message business object allows using the process agent framework. See, for example, the process agent framework illustrated in FIG. 10. If unknown messages will be detected by the GSF plug in for example which should also use the message business object for accessing and updating the message registry content, then an appropriate process agent can notify the responsible developers via regular workflow mechanism like email or business tasks.

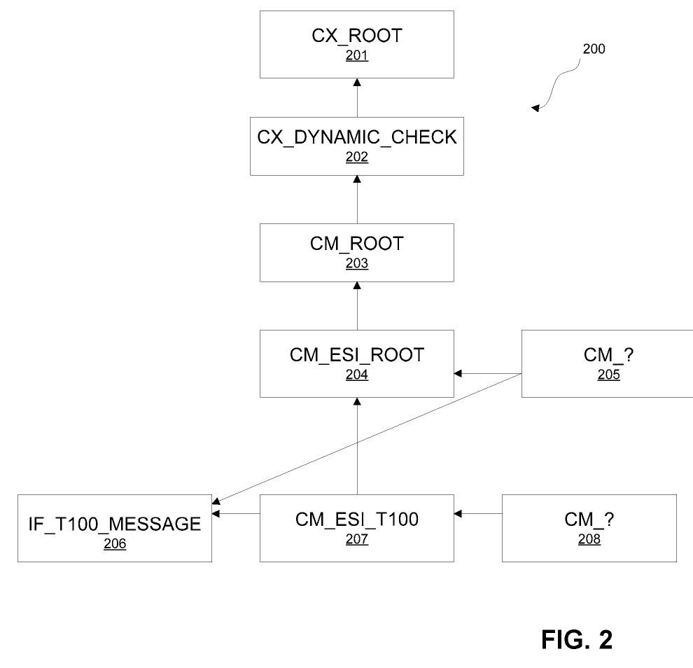

In FIG. 2, for example, an enterprise services infrastructure message class concept may be based on the ABAP (for example purposes) exception class mechanism. The class CM_ROOT 203 is the base class of all messages. It is derived from the exception class CX_DYNAMIC_CHECK 202 which itself is derived from CX_ROOT 201.

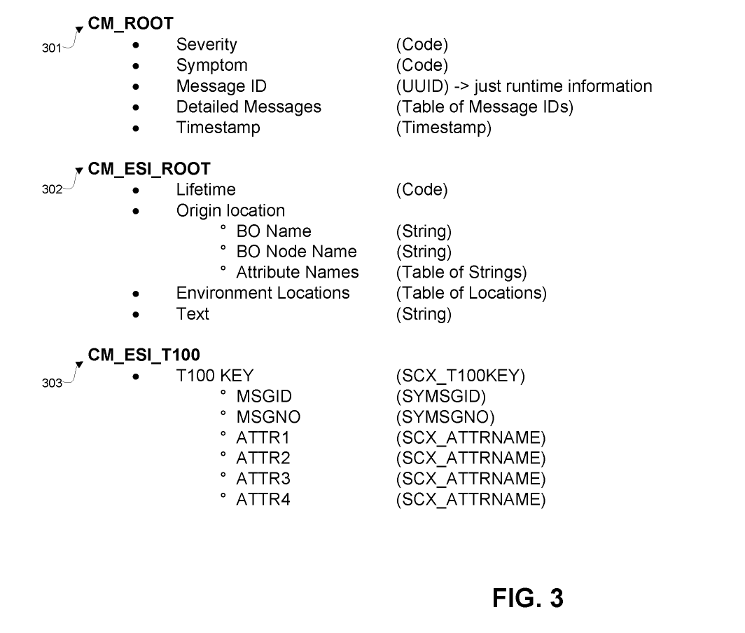

In FIGS. 2 and 3, an embodiment of the present invention is shown. For example, the message class CM_ROOT 203, 301 contains information about the message severity such as error, warning, information, or success and the message symptom such as configuration mismatch. Also, runtime information which is generated by the framework to identify the message uniquely such as message ID and detailed messages, and the timestamp are a part of the root class. The class CM_ESI_ROOT 204, 302 enriches the information with the lifetime and the location of the messages. The lifetime of the messages can be transition and/or state lifetime. The origin location of the message contains the business object name, the node name, the business object node id (identification), and the list of attributes to which the message is associated. In addition, the environment location attribute can include a list of message locations. These locations describe the message such as an error in the context of the environment of other nodes or other business objects. The class CM_ESI_T100 207, 303 enriches the information with attributes of the IF_T100_Message 206 message string for the & placeholder within the message text. Additional classes CM_? 205, 208 may be associated with the other classes.

In an embodiment, the message registry information is stored in a database as configuration tables. Here, the configuration tables are system tables. The dedicated records of the tables are transportable through the system landscape.

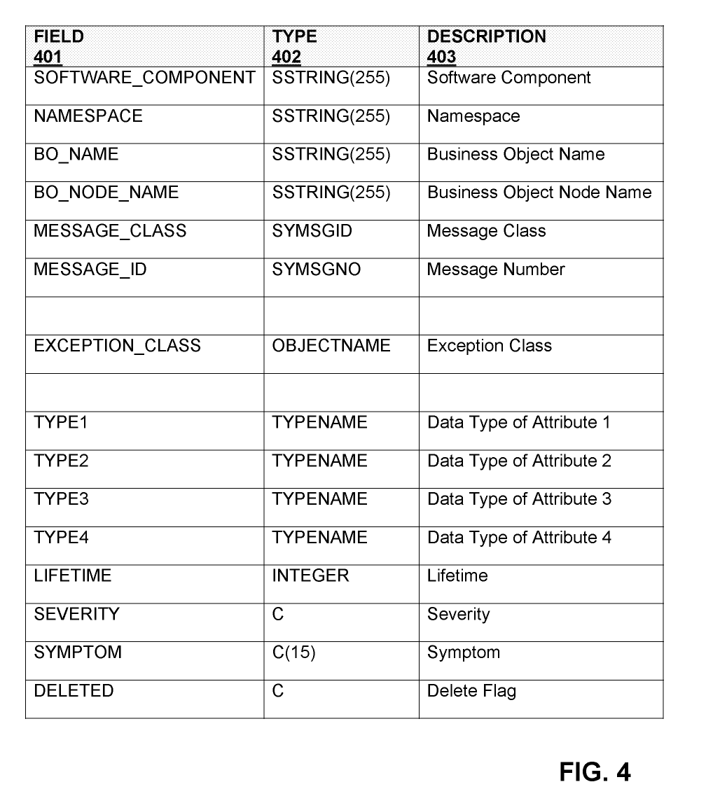

In FIG. 4, the message registry data scheme master includes the information about the T100 message class and message id associated to the business object and business object node. Specifically, the information is maintained in a database having various field(s) 401, types 402 associated with those fields, and a description 403 of those fields. These entities including the software component and the namespace are useful fields of the tables. In a further embodiment, the MD5 hashed string of the sorted field names may be part of the key structure to get the information of the occurred field combinations in real-life messages. In an embodiment, such granular information may be included, for purposes of message mapping. In FIG. 4, a variety of information is shown example information that can be a part of such a table. Of course, additional information and fields may be included as those shown are for example purposes.

In an embodiment, an exception class name (e.g., an ABAP exception class name) is part of the registry but the exception identifiers are not tracked at runtime. In an embodiment, the exception identifiers are tracked at runtime by, for example, the system or the developer. In an embodiment, other computer languages may be used to implement the various embodiments of the present invention.

In an embodiment, the attributes of the T100 message include plain text, which can be limited to a specified maximum length, e.g., of 50 characters without type information, so that it is not possible to convert local dependent data types. In an embodiment, the additional data type information may be added in a maintenance step by a developer. In an embodiment, the information is stored in the master table in four type fields. In such embodiments, for example, the master table includes the lifetime, severity, and the symptom of the message. In an embodiment, the symptom is relevant information for the generic error processing based on messages.

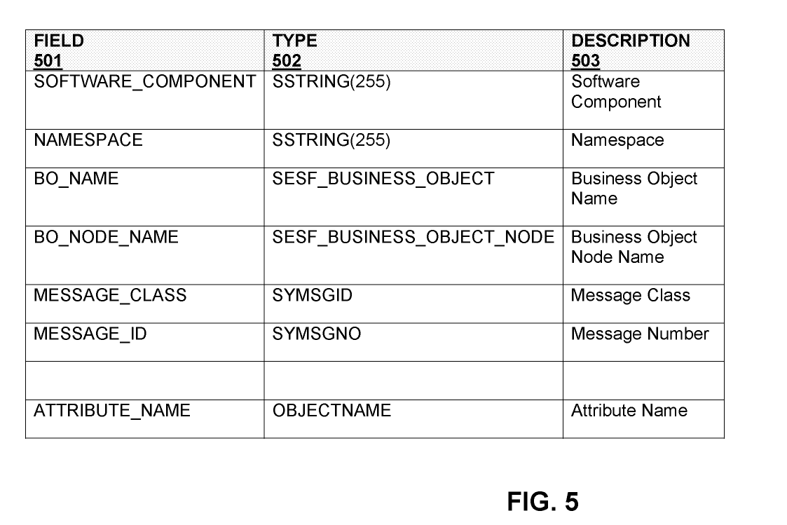

In FIG. 5, an example message registry data scheme and attributes is shown. The message registry data scheme attributes table includes the information about the attribute names of the fields 501 which are associated to the error. In some cases, for example, those fields contain invalid data. In an embodiment, via a user interface, those fields are highlighted and allow for navigation from the message area to this field(s). The example message registry scheme here also shows the type 502 and description 503 of the associate field.

In an embodiment, the entire data scheme includes additional information about the development lifecycle management. In an embodiment, if the message registry is transported through the system landscape, for example, the additional lifetime information on a record level must be managed. For example, this includes the situation that the messages can be markable as deleted.

In an embodiment, the system framework, for example, the ESF (Enterprise Services Framework), allows registration of core services listener. In an embodiment, the listener is called in pre- and post-notifications of the core service calls by the service manager.

In an embodiment, the GSF (Generic Services Framework) plug-in for the message registry may “listen in” on the ESF message handler. For example, each time the message handler is used by a service provider, the plug-in compares the raised messages against the content of the message registry. In the case that the raised messages are not stored in the registry, those messages are added to the registry. In an embodiment, this can be realized via a separate database connection so that it would not influence the transactional behavior of the running application. For example, the transaction may be committed as necessary for the GSF plug-in. This can be realized, for example, by using a function module with destination “NONE.” In this example, the remote function is executed in a separate session on the same application server. And, the plug-in is configured to write the transport entries for new messages automatically.

In an embodiment, the GSF provides the functionality of enabling and disabling special plug-ins. For example, the message registry plug-in should be deployed in the AP test systems. The plug-in may be enabled in the AP development system. In an embodiment, the registry data is transportable through the system landscape on demand.

In an embodiment, the user interface which is a part of the controller development studio must access the registry data to provide the possibility to maintain the content manually. For such a purpose, an appropriate read- and write-interface including a multi-user locking strategy is supported. For example, a technical business object which implements the persistence layer via a generic framework. For example such may involve the BOPF or GBOP. An example framework used supports also breakout-mechanism to implement custom logic. In the present invention, with the business object approach, the regular pattern user interface can also be used to realize the maintenance user interfaces based on the system floorplans.

The messages can also be manipulated in order to allow for handling in a business process platform. An embodiments of the present invention provides for a hierarchical message handling of business objects in a business process platform.

In an embodiment, a simple user interface message such as an error message, warning message, and success message, are not always provided in a manner useful to a user. This is because the business objects may have associated business objects which contain additional (and possibly useful) information concerning such error, warning and success messages. In an embodiment, in order to provide that additional information to a user, via, e.g., a user interface, the messages are maintained and/or associated in a hierarchical manner. In an embodiment, such an association includes a hierarchical message corresponding to a call stack and context. Within the hierarchy, for example, navigation to the assigned business object, business object node, and node identifier is allowed. Such navigation provides for a view of the overall context of the message in a hierarchy. In an embodiment, reused messages across different business objects can be recognized. In an embodiment, for example, the messages could be defined with ABAP/OO classes CM_* (such as those described herein) to avoid possibly inconvenient interpretation of the MSGNO (e.g., an error number) and MSGID (e.g., a work area). An embodiment uses classes, e.g., ABAP/OO classes, which can make use of such inheritance and polymorphism. For example, in a local client proxy scenario, business object implementations which use other business objects are provided with convenient methods for simple filtering, sorting, and grouping of messages, as well as a checking of its context(s). For example, message specific object attributes (such as those described herein) can be used.

An embodiment of the present invention provides a hierarchical display of such error and the like messages and corresponding details. An embodiment of the present invention provides a context assignment, e.g., for navigation support. An embodiment of the present invention provides a recognition of reused messages across multiple and different business objects. An embodiment of the present invention provides for usage of specific object attributes. An embodiment of the present invention provide for use of a “visitor pattern” for ABAP/OO classes CM_* and similar such functionality in other computer language systems.

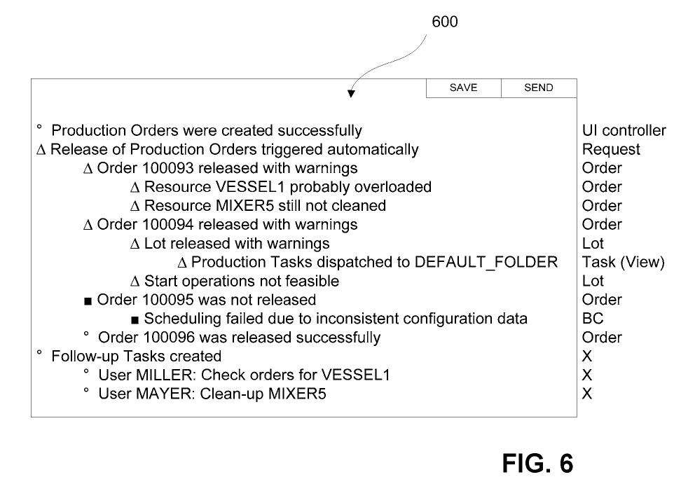

In FIG. 6, an example display 600 of messages from interacting business objects (BO) is shown. For example a hierarchical order corresponding to call stack and context is shown. And, subordinated messages are shown as a detailed explanation which can be collapsed and/or expanded for viewing reasons, etc. In FIG. 6, the example display shows that production orders were created successfully, that the request was that a release of the production orders be triggered automatically. The order itself is described, for example, Order 100093 was released with warnings. Such additional detail is provided. For example, resource VESSEL1 was probably overloaded, and the resource MIXER5 was not cleaned. In addition, information such as tasks may be provided and shown as well. Further, in addition to warnings, success and other messages may be provided. FIG. 6 also shows that associated followup tasks may be included in the showing.

In an embodiment, the message display keeps the original sequence of messages on its respective hierarchy level. In an embodiment, the message display supports long texts (e.g., formatted long texts) including, e.g., hyperlinks (e.g., a hyperlink to a help library or resource). In an embodiment, a message display provides for use of front-end language which may change within a session. In an embodiment, a message display translates code values automatically and/or manually. In an embodiment, a message display maps messages from a backend model to a specific screen layout and/or context. In an embodiment, a message display provides for same mapping options as for an application log as for user interface screens.

In an embodiment, navigation is provided to an origin location and environment location. In an embodiment, navigation is provided via an automatic tab-strip switch and/or tree expansion. In an embodiment, support is provided for large message trees, e.g., an application log. In an embodiment, functionality in the large message trees is searchable. In an embodiment, visual aggregation of the classes and fields in the large message trees is shown.

In an embodiment, the mapping of the messages is based on attributes. In an embodiment, the mapping of messages is based on application logic. For example, a service defines a specific interface(s) which is implementable by choice of application in a specific set (having one or more) of message classes. For example, to continue the example embodiments described above, the message classes may be ABAP/OO message classes. In an embodiment, a service may check whether message objects implement certain interfaces. For example, a query can be made for more specific information for mapping in a predefined or known format. In an embodiment, an example mapping based on application logic in the ABAP language may be IF_AP_MESSAGE_ACTION˜RUNS_ALL_OR_NOTHING( ): BOOL. In an embodiment, a mapping of the message object tree structure is made. For example, one message is created out of the many messages.

In an embodiment, a message handler is provided via the ESF (Enterprise Services Framework) which may do one or more of: accepting messages from an application, not allowing lookup, update or deletion, and allowing handover of messages to a consumer or other. In an embodiment, a message may be automatically installed by the ESF. Options may be set, including, for example, a root node corresponding with a message collection; and/or a root node corresponds with a single message (to provide hierarchy). In an embodiment, a message CO in the ESF framework can provide a message tree with business object nodes. For example, user interface building blocks can be used via the API (application programming interface). In an embodiment, the message in the ESF framework can provide associations to origin locations. For example, an aggregation of messages takes place. For example, one message line associates to many business object nodes. In an embodiment, a message in the ESF framework supports business object actions such as SEND, DOWNLOAD, SORT, and PRINT.

In an embodiment, a service provider returns messages to the, e.g., ESF framework (or other applicable framework), and receives messages from, e.g., LCP (Local Client Proxy) (and/or via another applicable protocol) calls. In an embodiment, the service provider filters, sorts, and groups the received messages. In an embodiment, the service provider checks a message where there appear to be functional gaps in the ESF, e.g., an action call. In an embodiment, the service provider handles messages and/or exceptions of internal runtime. In an embodiment, the service provider provides more detailed messages for embedded support.

In an embodiment, the outbound agent checks failed node and/or change notifications. In an embodiment, the outbound agent creates messages concerning the failed node and/or change notifications. In an embodiment, an inbound agent modifies business objects. An inbound agent also may check change notifications. In an embodiment, an inbound agent checks message(s) where the ESF has functional gaps, e.g., an action call. In an embodiment, an inbound agent checks message symptoms (e.g., as described above).

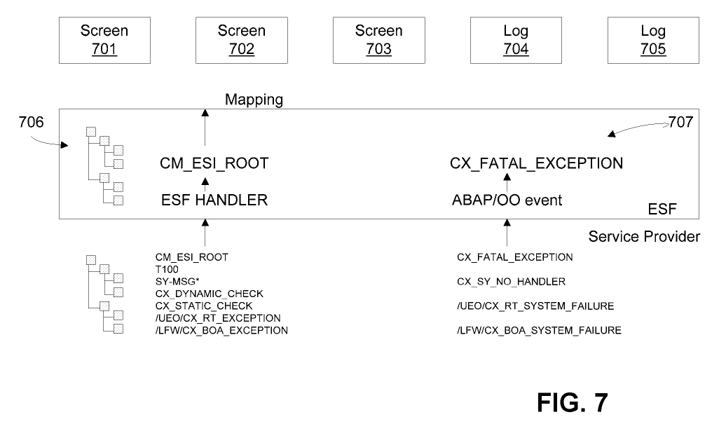

FIG. 7 shows an example embodiment of the message mapping. For example, various screens 701, 702, 703 and logs 704, 705 may be provided. The mapping from, for example, an application system functional with the ESF. The mapping 706 of the CM_ESI_ROOT includes an expandable/collapsible tree including the checks and exceptions. The CX_FATAL_EXCEPTION 707 is displayed, along with the history of associated exceptions and system failures. The ESF Handler then takes that information associated with the CM_ESI_ROOT from the service provider into the ESF or other applicable framework to provide it to the application to be logged and/or displayed to a user.

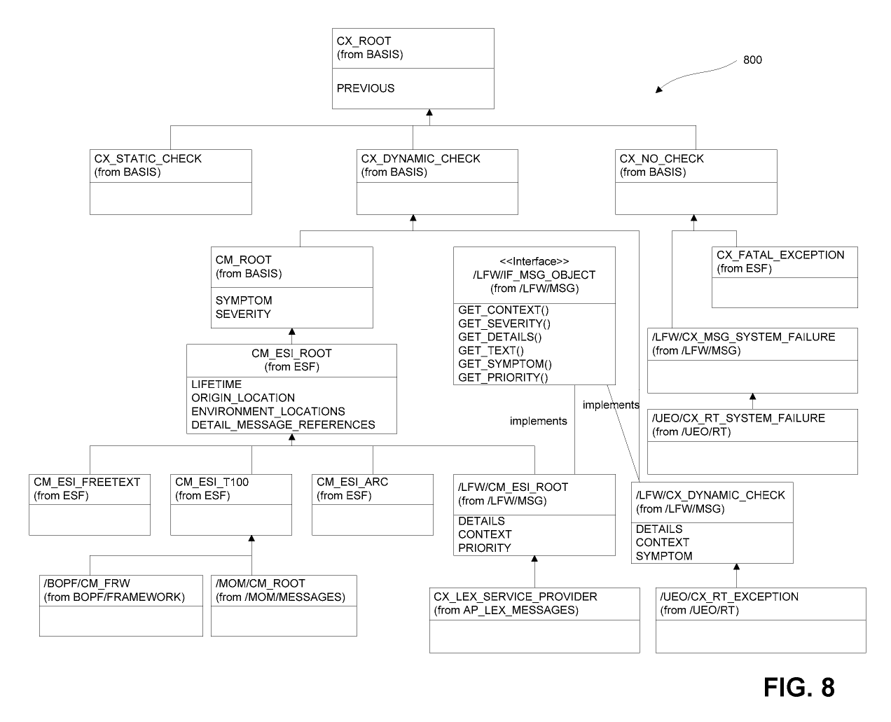

FIG. 8 shows a tree structure 800 including a variety of example exceptions, associated message classes, and T100. For example, the message classes are shown in terms of object modeling. Here, ABAP/OO message classes are shown for example purposes. Any other applicable language may be used in this scenario. Here, the message classes use text from T100 or OTR (online text repository—usable for unformatted long texts).

In an embodiment, in a message class hierarchy, the hierarchy is based on one sorting criteria. In an embodiment, the sorting criteria includes something more specific than a generic attribute like symptom or business object name. In an embodiment, the sorting criteria matches the semantic of the messages, allowing for ease of sorting and comprehensive sorting. In an embodiment, the sorting takes into account the various technical attributes so that correct inheritance of the specific technical attributes occurs. In an embodiment, specific attributes are used as text parameters. In an embodiment, in a message object tree, the subordinated message object(s) are seen as details of the parent message object(s). In an embodiment, semantic checks are done in the message object tree.

In an embodiment, an analyzer is used to sort the messages into a hierarchical fashion. For example, an analyzer such as LEX (a lexical analyzer generator) is used in conjunction with the existing platform software. An example expression may specify a set of strings to be matched. For example, text characters (e.g., alphabet, digits) are used which match the corresponding characters in the strings being compared. Operator characters are used which specify repetitions, choices, and other features. For example, an expression of “integer” finds matches to all strings of “integer.” For example, an expression of “a12b” finds the string “a12b.”

In an embodiment, LEX message classes are used to provide for easier recognition of reused messages across business objects for a front-end user. In an embodiment, the LEX message classes are used to provide for less text and more consistency for development purposes. In an embodiment, LEX message classes are used to provide to consumers, e.g., LCP (Local Client Proxy) consumer, a handle on a smaller set of reused messages. In an embodiment, LEX message classes are used to allow for improvements in generic message creation for an application on the framework level.

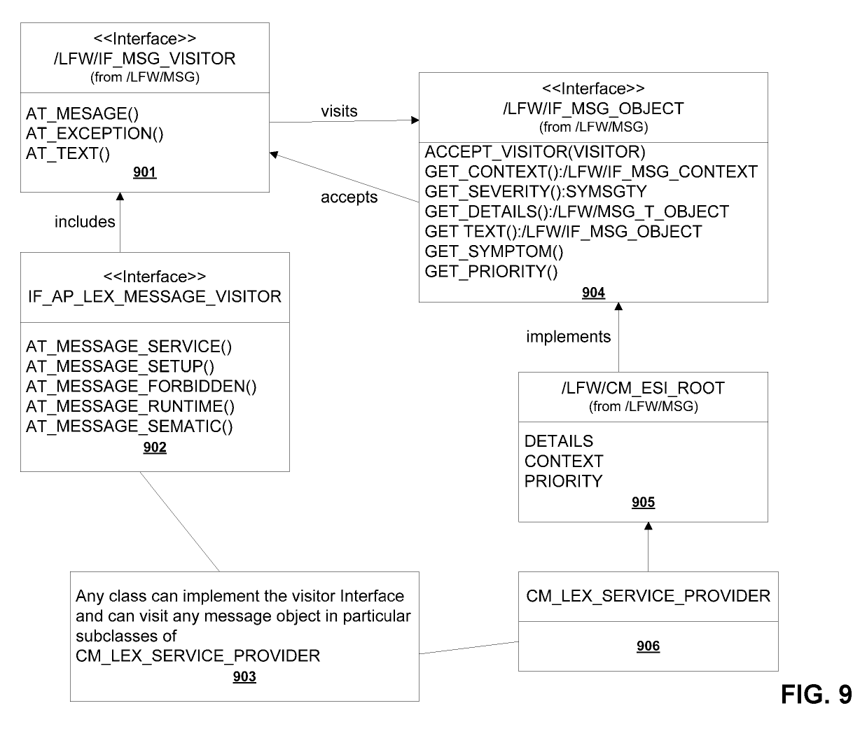

In FIG. 9, an example LEX message visitor is shown. In an embodiment, a visitor interface provides callback methods for known or abstract messages. In an embodiment, each message class implements a callback in a specific way, as defined by that message class. In an embodiment, each application can defined additional and/or more specific visitors, and/or can define more specific message subclasses. In FIG. 9, the LEX message visitor 901 or visitor interface is shown as interfacing or visiting with a message object 904. The message object 904 gets the various fields, e.g., context, severity, details, text, symptom, and priority, desired. The details of the CM_ESI_ROOT object 905 including details, context, and priority are provided to the message object 904. The LEX message visitor 901 also may communicate with other LEX message visitors 902. As noted in FIG. 9, any message class 903, for example, can implement the visitor interface to visit any message object. Here, for example, the subclasses of the CM_LEX_SERVICE_PROVIDER 906 can be accessed.

In FIG. 10, an example process agent framework is shown. For embodiments of the present invention, in a process agent framework, for example, a flexible message-based integration is provided. In such framework, process agents are used for synchronous and asynchronous cross-component communication. Communications are generally conducted asynchronous, except for those instances desired to be for synchronous communications. The process agents execute the integration logic and separate it from the business logic. The new process agents can be added without changing the business object. Such is supported by the process agent format with generic services like process history, error handling, and sequencing.

A message in, e.g., web service (WS) runtime in a service layer 1008 communicates to the process agent framework 1004. The process agent framework 1004 includes a resolution assignment 1004A, an error/conflict handler 1004B, and an error log 1004C. The process agent framework 1004 communicates with an inbound process agent 1006. Any error message gets returned to the service layer 1008. From the process agent framework 1004, a communication is relayed to the business task management (BTM), then to the universal worklist 1003, process agent framework error user interface module 1002, and ultimately to the user via the user interface 1001.

When there is an error message, for example, subclasses of CM_ROOT with symptom, severity, etc. are used. A set of rules of use may be defined by the application. A controller evaluates the rules based on message symptom and the service interface.

An example method that may occur in association with an inbound process agent is as follows. The process agent is initalized, i.e., an RBD or other information is stored for process agent processing. Business object (BO) instances are locked to protect BO instances against parallel processing. The message content is checked, i.e., correctness of the message format and content is verified. The business object is modified or updated in a relevant manner from data mapped. Modifications are retrieved and specifically saved then by the framework. Such information concerning the business or data model involved may be prepared for saving. An enterprise service framework layer or other save may then be triggered and any information update is logged.

In embodiments of the present invention, message handling of an error, success, other message which is associated in some way to another message is provided. For example, a grid structure or tree structure is provided. In an alternative embodiment of the present invention, messages are shifted as opposed to being in a tree or grid structure. Earlier error codes and/or messages were not associated with earlier error codes. A user needed to read through the description texts in order to get an idea of what occurred and from where the error or other situation came. Error messages were not modeled in earlier systems. Accordingly, in an embodiment of the present invention, the error messages are modeled and a registry is provided in order to make associations between the business objects.

In an embodiment of the present invention, the hierarchy of messages are registered so that the propagation and details of errors and other messages are available to a user or system when determining a fault or other situation. Such embodiments allow for a drilling down into the specifics to determine what happened in a situation. As shown in the embodiments herein, the hierarchy of messages can be based on attributes or detailed message references in a table, grid, or tree. In embodiments of the present invention, a user or consumer can build their own hierarchy as defined by their own system and/or business needs by associating each message with another message via the sorting query or other methods, for example, discussed above or are apparent variations of the embodiments described herein.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

It should be understood that there exist implementations of other variations and modifications of the invention and its various aspects, as may be readily apparent to those of ordinary skill in the art, and that the invention is not limited by specific embodiments described herein. Features and embodiments described above could be combined. It is therefore contemplated to cover any and all modifications, variations, combinations or equivalents that fall within the scope of the basic underlying principals disclosed and claimed herein.

What is claimed is:

1. A method for handling a notification message in a service-oriented business framework, comprising:
saving a transaction;
in response to the saving of a transaction, sending a notification message to the business framework, the notification message containing an associated message class including information of message severity and message symptom,
wherein the business framework includes a controller layer situated between a service management layer and a business object layer, the controller layer maintaining a message registry database which collects and stores the notification message and the information of message severity, message symptom, and message identification.

2. The method of claim 1, wherein the service-oriented business framework is one of an enterprise services framework and an enterprise service-oriented architecture.

3. The method of claim 1, wherein the notification message is at least one of: an error message and a success message.

4. The method of claim 1, wherein the message severity indicates one of successful transaction save, error in transaction save, warning regarding transaction save, and information regarding transaction save.

5. The method of claim 3, wherein the message symptom includes one of configuration appropriate and configuration inappropriate.

6. The method of claim 5, wherein the message identification includes at least one of a unique identifier for the notification message and a timestamp.

7. The method of claim 6, wherein the unique identifier includes a business object name, a node name, a business object node id, and a list of attribute(s), associated with the message.

8. The method of claim 1, wherein the business framework displays the generated message for a specific saved transaction.

9. The method of claim 1, wherein a text of the message is configurable.

10. The method of claim 1, wherein the database includes at least one configuration table which is transportable within the business framework.

11. A computer-readable medium including instructions adapted to execute a method for handling a notification message in an enterprise services framework, comprising:
saving a transaction;
in response to the saving of a transaction, sending a notification message to the enterprise system framework, the notification message containing an associated message class including information of message severity and message symptom,
wherein the enterprise services framework includes a controller layer situated between a service management layer and a business object layer, the controller layer maintaining a message registry database which collects and stores the notification message and the information of message severity, message symptom, and message identification.

12. The method of claim 11, wherein the notification message is at least one of: an error message and a success message.

13. The method of claim 11, wherein the message severity indicates one of successful transaction save, error in transaction save, warning regarding transaction save, and information regarding transaction save, and wherein the message symptom includes one of configuration appropriate and configuration inappropriate.

14. The method of claim 11, wherein the message identification includes at least one of a unique identifier for the notification message and a timestamp.

15. The method of claim 14, wherein the unique identifier includes a business object name, a node name, a business object node id, and a list of attribute(s), associated with the message.

16. The method of claim 1, wherein the database includes at least one configuration table which is transportable within the enterprise services framework.

17. A system for handling a notification message in an enterprise services framework, comprising:
a notification message, the notification message containing an associated message class, including information of message severity and message symptom,
wherein upon the saving of a transaction in the enterprise services framework, the notification message is generated and sent to the enterprise services framework, and
wherein the enterprise services framework includes a controller layer situated between a service management layer and a business object layer, the controller layer maintaining a message registry database which collects and stores the notification message and the information of message severity, message symptom, and message identification.

18. A method for the hierarchical handling of software objects in a business process platform, comprising:
providing a first software object associated with a first user interface message;
providing a second software object associated with a second user interface message, wherein the second software object is associated with the first software object,
hierarchically associating the first interface message with the second interface message based on the association of the first software object and the second software object,
wherein the hierarchically associated messages are displayed in a tree structure in association with each of the first and second software objects.

19. The method of claim 18, wherein the user interface message is at least one of: an error message, a warning message, and a success message.

20. The method of claim 18, wherein the hierarchically associating is effected by at least one of: filtering of messages, sorting of messages, grouping of messages, and checking context of messages.

21. The method of claim 18, wherein each of the first and second software objects include an associated business object node and node identifier, and wherein a reusing of the user interface message from the first software object in a hierarchical association in the second software object includes an information of at least one of the associated business object node and the node identifier of the first software object in the second software object to allow for navigation.

22. A system for the hierarchical handling of software objects in a business process platform, comprising:
a first software object associated with a first user interface message;
a second software object associated with a second user interface message, wherein the second software object is associated with the first software object,
wherein upon hierarchically associating the first interface message with the second interface message based on the association of the first software object and the second software object, the hierarchically associated messages are displayed in a tree structure in association with each of the first and second software objects.

23. The system of claim 22, wherein the user interface message is at least one of: an error message, a warning message, and a success message.

24. The system of claim 22, wherein the hierarchically associating is effected by at least one of: filtering of messages, sorting of messages, grouping of messages, and checking context of messages.

25. The system of claim 22, wherein each of the first and second software objects include an associated business object node and node identifier, and wherein a reusing of the user interface message from the first software object in a hierarchical association in the second software object includes an information of at least one of the associated business object node and the node identifier of the first software object in the second software object to allow for navigation.

26. A computer-readable medium including instructions adapted to execute a method for hierarchical handling of software objects in a business process platform, the method comprising:
providing a first software object associated with a first user interface message;
providing a second software object associated with a second user interface message, wherein the second software object is associated with the first software object,
hierarchically associating the first interface message with the second interface message based on the association of the first software object and the second software object,
wherein the hierarchically associated messages are displayed in a tree structure in association with each of the first and second software objects.

27. The medium of claim 26, wherein the user interface message is at least one of: an error message, a warning message, and a success message.

28. The medium of claim 26, wherein the hierarchically associating is effected by at least one of: filtering of messages, sorting of messages, grouping of messages, and checking context of messages.

29. The medium of claim 26, wherein each of the first and second software objects include an associated business object node and node identifier, and wherein a reusing of the user interface message from the first software object in a hierarchical association in the second software object includes an information of at least one of the associated business object node and the node identifier of the first software object in the second software object to allow for navigation.
